(19) United States
(12) Patent Application Publication
(10) Pub. No.: US 2011/0044194 A1
(43) Pub. Date: Feb. 24, 2011

(54) BASE STATION APPARATUS

(75) Inventor: Jun Kitakado, Gifu (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/920,076

(22) PCT Filed: Feb. 24, 2009
(86) PCT No.: PCT/JP2009/000811

§ 371 Date: Aug. 27, 2010

(30) Foreign Application Priority Data
Feb. 29, 2008 (JP) 2008-050594

(51) Int. Cl. H04L 12/26; H04W 72/04

(52) U.S. Cl. 370/252; 370/329

(57) ABSTRACT

A receiver receives a request for channel assignment from a terminal apparatus. Triggered by the receipt of the request by the receiver, a channel measurement unit performs carrier sense of channels defined by a combination of a frequency resource and a temporal resource. The channel measurement unit assigns any of the channels, on which the carrier sense has been performed, to the terminal. When a plurality of channels are assigned to the same terminal apparatus, a channel to be assigned is selected in consideration of the channels which have already assigned to the terminal apparatus.

### TECHNICAL FIELD

The present invention relates to a channel allocation technology, and it particularly relates to a base station apparatus for assigning channels to terminal apparatuses.

### BACKGROUND TECHNOLOGY

In recent years, a higher data transmission rate is desired in the field of wireless communications as well. A higher data transmission rate may be achieved, for instance, when a single terminal simultaneously communicates using a plurality of channels (hereinafter referred to as “multi-channel communications”). To perform the multichannel communication, a base station monitors the level of interference waves arriving from surrounding stations and thereby searches for time slots and carriers at which presumably no interference waves arrives and which therefore have a satisfactory quality of communications. Based on the search results, the base station determines time slots and carriers to be assigned to terminal apparatuses, in accordance with the quality of communications required by the terminal apparatuses.

However, since such assignment of time slots and carriers is done in order of requirement, the best possible channel is allocated to a terminal, for example, to which the channel is first assigned even though a low-quality communication, namely a low data transmission rate, is actually required in this terminal, for example. In such a case, if there is a terminal requesting a high-quality communication, namely a high data transmission rate, in the next queue, there may be no proper channel assigned to such a terminal. To address such a problem, a conventional technique in which several channels with satisfactory quality are kept beforehand is disclosed (see Patent Document 1, for instance), so that an optimal channel in accordance with the quality required by the terminal can be assigned.

[Patent Document 1] Japanese Patent Publication No. Hei11-262044.

### DISCLOSURE OF THE INVENTION

### Problems to be Solved by the Invention

Communication environments may vary after the channel has been assigned. For example, there are cases where the communication quality drops when the interference occurs due to delayed waves. In such a case, the ongoing communication is interrupted and the re-assignment processing must be carried out, thereby making it inefficient.

The present invention has been made in view of the foregoing circumstances, and a purpose thereof is to provide a technique capable of efficiently assigning channels.

### Means for Solving the Problems

In order to resolve the above problems, a base station apparatus according to one embodiment of the present invention comprises: a receiver configured to receive a request for channel assignment from a terminal apparatus; a measurement unit configured to perform carrier sense of channels defined by a combination of a frequency resource and a resource other than the frequency resource, upon receipt of the request by the receiver; and a channel allocation unit configured to assign any of the channels, on which the carrier sense has been performed by the measurement unit, to the terminal. When a second channel and channels subsequent thereto are further assigned to the same terminal apparatus, the channel allocation unit assigns a channel having the same frequency as that of a frequency resource in such a manner that the frequency resource of the already assigned channel is prioritized over the other resources.

Optional combinations of the aforementioned constituting elements, and implementations of the invention in the form of methods, apparatuses, systems, recording media, computer programs and so forth may also be practiced as additional modes of the present invention.

### EFFECT OF THE INVENTION

The present invention allocates the channels efficiently.

### BRIEF DESCRIPTION OF THE DRAWINGS

FIG. 1 illustrates an exemplary structure of a base station apparatus according to an embodiment of the present invention.

FIG. 2 illustrates an example of a plurality of channels from which a selection is to be made by a channel measurement unit of FIG. 1.

FIG. 3 illustrates an example of an allocation management table stored in memory of FIG. 1.

FIG. 4A shows a first exemplary assignment in a channel allocation unit of FIG. 1.

FIG. 4B shows an example of an allocation management table in the exemplary assignment of FIG. 4A.

FIG. 5A shows a second exemplary assignment in a channel allocation unit of FIG. 1.

FIG. 5B shows an example of an allocation management table in the exemplary assignment of FIG. 5A.

FIG. 6 shows an exemplary operation of a base station apparatus of FIG. 1.

### DESCRIPTION OF THE REFERENCE NUMERALS

10 Receiver
20 Channel measurement unit
40 Memory
50 Channel allocation unit
60 Transmitter
100 Base station apparatus
200 Channel
400 Assigned channel
500 Assignment candidate channel
600 Allocation management table

### BEST MODE FOR CARRYING OUT THE INVENTION

An embodiment of the present invention will be first outlined before the specifics thereof are explained. The embodiment of the present invention relates to a channel allocation technology. The channel allocation technology is a technique in which a base station apparatus, which receives a request from a terminal apparatus, selects an optimal channel and assigns the selected channel to the terminal apparatus. The assignment of the optimal channel enables an increase in the communication quality, so that the terminal apparatus can execute comfortable and smooth communications. Also, the improved quality of communications suppresses the number of retransmissions, thus enabling the efficient use of a system resource. The optimal channel is determined in consideration of the quality of service (QoS) of communications requested by terminal apparatuses.

Channels to be allocated differ from each other depending on a communication scheme used. For example, time slots are allocated in a TDMA (Time Division Multiplex Access) scheme, and a frequency is allocated in an FDMA (Frequency Division Multiple Access) scheme. A description will be given below of a case where a multicarrier TDMA scheme is used for the convenience of explanation but the communication scheme used is not limited thereto.

In the multicarrier TDMA scheme, a assignable channel is defined by a combination of a frequency resource and a temporal resource. Thus, the base station apparatus selects a usable channel from among a plurality of frequency bands and a plurality of time slots. Nevertheless, even if communications are performed using the selected channel, the communication quality may deteriorate if, for example, delayed waves occur. Whether there are delayed waves or not is heavily dependent on the positional relationship between a base station and a terminal as well as the frequency, and therefore it cannot be determined before the communication is actually performed.

Hence, if a plurality of channels are to be assigned to the same terminal apparatus, the base station apparatus according to an embodiment of the present invention will select a channel to be assigned, in consideration of the channel which has already been assigned to said terminal apparatus. By employing this embodiment, the optimal channel with a minimized effect of the delayed waves can be allocated.

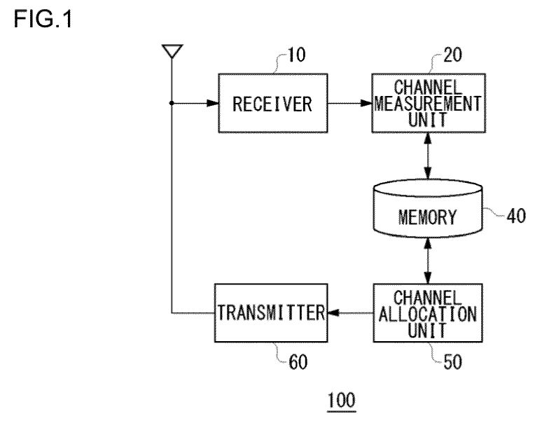

FIG. 1 illustrates an exemplary structure of a base station apparatus 100 according to an embodiment of the present invention. The base station apparatus 100 includes a receiver 10, a channel measurement unit 20, a memory 40, a channel allocation unit 50, and a transmitter 60. As for the processing and the like concerning the communication with a wired network, the base station apparatus 100 may carry out the processing and the like using the conventional technique and therefore the description thereof is omitted here.

The receiver 10 receives a request signal for channel assignment sent from a terminal apparatus (hereinafter “terminal apparatus” will be referred to as “user” also). The request signal contains an identification number indicating an originating terminal apparatus and a signal requesting the assignment of a channel. Also, the receiver 10 receives signals arrived from other stations. The receiver 10 demodulates the received signals and sends the demodulated signals to the channel measurement unit 20. The demodulation processing, which includes filter processing, error correction, and so forth, may be conducted using a known technique.

The channel measurement unit 20 performs carrier sense of the signals arrived from other stations. The carrier sense is conducted by measuring the level of interference waves for each of channels from which a selection is to be made.

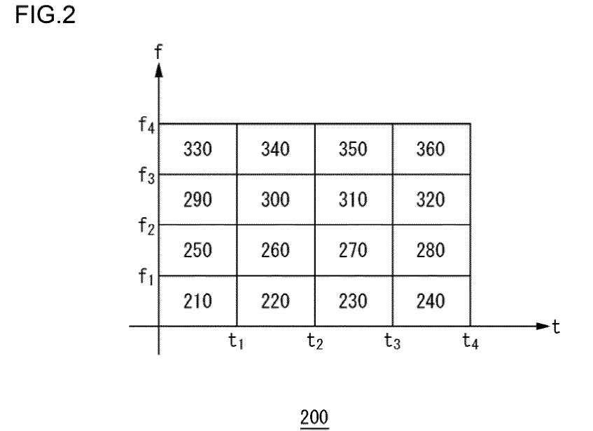

FIG. 2 illustrates an example of a plurality of channels 200 from which a selection is to be made by the channel measurement unit 20 of FIG. 1. The horizontal axis represents the time slots, whereas the vertical axis represents the frequency. As shown in FIG. 2, there are sixteen channels, which are a first channel 210 to a sixteenth channel 360, as channels 200 from which a selection is to be made. Shown here is a case where the number of frequency carriers is four and the number of time slots is four but the present embodiment is not limited thereto.

FIG. 2 shows channels for a single frame. Each frame has an identical structure. In other words, the base station apparatus 100 assigns a channel which is to be used the same way as in each frame; once the channel is assigned, the same channel will be repeatedly used in said each frame. For example, assume that the sixth channel 260 of FIG. 2 is assigned to a terminal apparatus X. Then the terminal apparatus X will use the sixth channel 260 no matter which frame is used.

Now refer back to FIG. 1. The channel measurement unit 20 measures the interference wave levels of their respective channels 200 composed of the first channel 210 to the sixteenth channel 360, and stores a comparison result, obtained by comparing the measured levels against a threshold value, in the memory 40. Its details will be discussed later.

The memory 40 stores the comparison result obtained by comparing the levels of interference waves, measured by the channel measurement unit 20, against the threshold value. Also, the memory 40 stores information on an assigned user of each channel selected by the channel measurement unit 20, in an allocation management table 600.

The channel allocation unit 50 accesses the memory 40 and references the allocation management table 600 so as to assign a channel to a terminal apparatus requesting the channel assignment. Also, the channel allocation unit 50 stores an allocation result in the memory 40. Its details will be discussed later. Further, the channel allocation unit 50 has information on the assigned channel contained in a transmitting signal transmitted to said user. The transmitter 60 transmits the transmitting signal, in which the information on the assigned channel is contained, to said user.

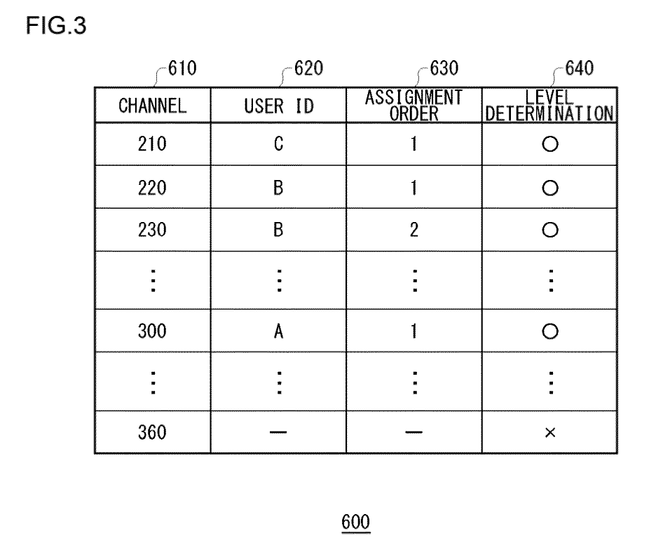

FIG. 3 illustrates an example of the allocation management table 600 stored in the memory 40 of FIG. 1. The allocation management table 600 includes a channel column 610, a user ID column 620, an assignment order column 630, and a level determination column 640. Identifiers indicating the channels 200 shown in FIG. 2 are contained in the channel column 610.

Identifiers on terminal apparatuses to which the respective channels 200 indicated in the channel column 610 are allocated are contained in the user ID column 620. The assignment order column 630 contains assignment orders. Note that if more than one channel 200 are assigned to the same terminal apparatus, the “assignment order” indicates an order in which each channel 200 is assigned.

In the allocation management table 600 shown in FIG. 3, user C is assigned to the first channel 210; user B is assigned to the second channel 220 and the third channel 230; and user A is assigned to the tenth channel 300. FIG. 3 also shows that no user is assigned to the sixteenth channel 360. FIG. 3 also shows that the second channel 220 is a channel 200 to which user B is assigned for the first time and that the third channel 230 is a channel 200 to which the same user B is assigned for the second time.

The level determination column 640 is a space showing a comparison result in which the level of interference wave is compared with a predetermined threshold value. If a channel 200 shown in the channel column 610 has an interference wave level lower than the predetermined threshold value, its space in the level determination column 640 will be marked with “∘” (circle). If it has an interference wave level higher than or equal to the predetermined threshold value, its space in the level determination column 640 will be marked with “x” (cross). In the allocation management table 600 of FIG. 3, the interference wave levels of the first channel 210, the second channel 220, the third channel 230 and the tenth channel 300 are smaller than the threshold value, whereas the interference wave level of the sixteenth channel 360 is larger than or equal to the threshold value.

A detailed description will be given herein of the channel assignment in the channel measurement unit 20 and the channel allocation unit 50. Triggered by the receipt of a request at the receiver 10, the channel measurement unit 20 performs carrier sense of the respective channels 200 shown in FIG. 2. The channel measurement unit 20 stores the execution result of carrier sense. More specifically, the channel measurement unit 20 stores the comparison result, in which the level of interference wave is compared with the predetermined threshold value, for each of the channels 200 in the level determination column 640 of the allocation management table 600 in the memory 40.

Then, the channel allocation unit 50 assigns any one of channels 200 to each terminal apparatus in consideration of the level of interference wave of each channel 200 stored in the memory 40. Also, the channel allocation unit 50 stores the correspondence between the assigned channels 200 and the terminal apparatuses, in the channel column 610 and the user ID column 620 of the allocation management table 600.

More specifically, the channel allocation unit 50 first references the allocation management table 600 stored in the memory 40 and checks whether or not a channel 200 has already been assigned to the terminal requesting the assignment. If there is no terminal requesting the assignment in the user ID column 620 of the allocation management table 600, the channel allocation unit 50 will assign a channel 200, selected from among a plurality of channels 200 measured by the channel measurement unit 20, to the terminal apparatus. Here, the channel 200 selected from among the plurality of channels 200 measured by the channel measurement unit 20 is a channel which has not yet assigned to any other terminal apparatuses and which has the most satisfactory quality.

The quality is determined to be higher if the interference wave level is smaller. In a decision-making process, the interference wave level may be compared against a predetermined threshold. A channel 200 which has becomes smaller than the threshold value may be selected as an assignable channel. The threshold value may be determined based on QoS required by the terminal apparatus. For ease of explanation, a channel 200 which is not assigned to the other terminal apparatuses and which has an interference wave level smaller than the threshold value will be referred to as “assignable channel” in the following description.

If, on the other hand, any terminals requesting the assignment exist in the user ID column 620 of the allocation management table 600, the channel allocation unit 50 will assign an assignable channel for the second time and its subsequent assignable channels in consideration of the channels 200 assigned to said terminal apparatus in the past. More specifically, the channel allocation unit 50 references the allocation management table 600 and verifies the channels 200 assigned in the past. Then, the channel allocation unit 50 searches and retrieves channels 200 having the same frequency as that of the channels assigned in the past.

The degree of the effect of delayed waves on the communication quality differs if the frequency differs. Thus, the frequency actually used for the communications in the past is more suitable. Accordingly, a channel available not in the time direction but in the frequency direction is preferentially selected as the second channel; a channel 200 assigned in the past is used as reference in the selection of the second channel. If a plurality of channels 200 are searched and retrieved, the channel allocation unit 50 will select a channel 200 whose interference wave level is small (hereinafter, this will be called “allocation selection processing”).

If there is a plurality of such channels 200 as were assigned in the past, the channel allocation unit 50 will reference the assignment order column 630 of the allocation management table 600. Then the channel allocation unit 50 preferentially assigns a channel 200 having the same frequency as that of the channel 200 used most recently. If there is no such a channel 200 having the same frequency as that of the channel 200 used most recently, a channel 200 assigned immediately before that assigned most recently may be considered. Also, a channel 200 having the same frequency as that of the channel assigned first may be assigned.

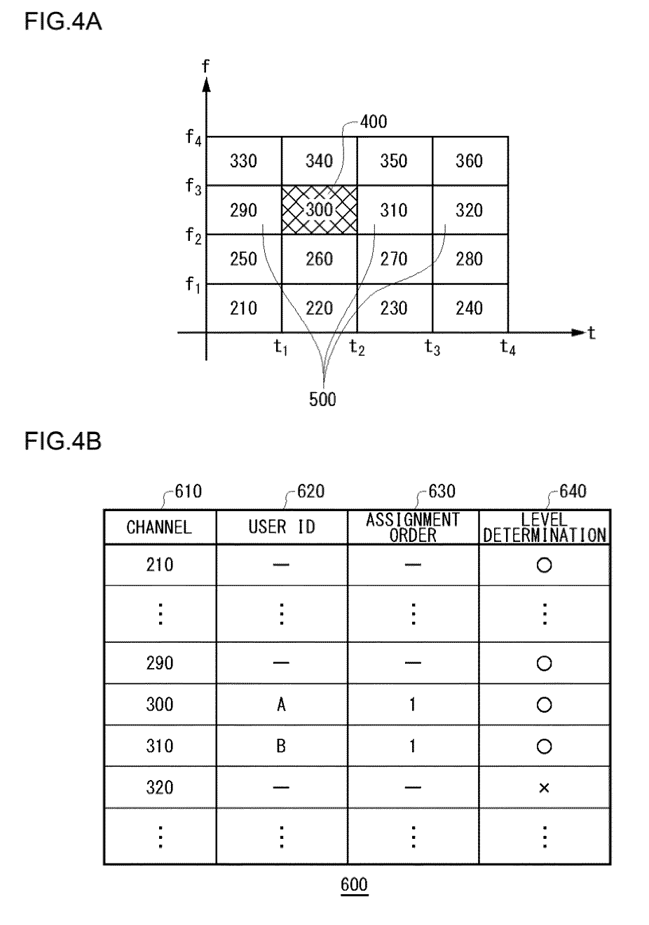

A description is now given using a specific example. FIG. 4A shows a first exemplary assignment in the channel allocation unit 50 of FIG. 1. In this example, it is assumed that the channel assignment request is made again by a terminal apparatus A to which the tenth channel 300 has already been assigned. In this case, the channel allocation unit 50 first searches and retrieves the ninth channel 290, the eleventh channel 310 and the twelfth channel 320 which have the same frequency as that of the already-assigned tenth channel 300, and selects these as assignment candidate channels 500. Out of the three assignment candidate channels 500, the channel allocation unit 50 determines an assignable channel for the terminal apparatus A after carrying out the allocation selection processing.

Assume herein that the content of the allocation management table 600 is as shown in FIG. 4B. FIG. 4B shows an example of the allocation management table 600 in the exemplary assignment of FIG. 4A. As shown in the Figure, the eleventh channel 310 has already been assigned to a different terminal, which is a terminal apparatus B here. Also, the twelfth channel 320 has an interference wave level higher than the predetermined threshold value. Thus, in the case of such a condition as that shown in FIG. 4B, the assignable channel will be the ninth channel 290 only. The channel allocation unit 50 selects the ninth channel 290 as the channel assigned to the terminal A. If there is a plurality of such assignable channels 200, the channel allocation unit 50 will select an assignable channel through the allocation selection processing.

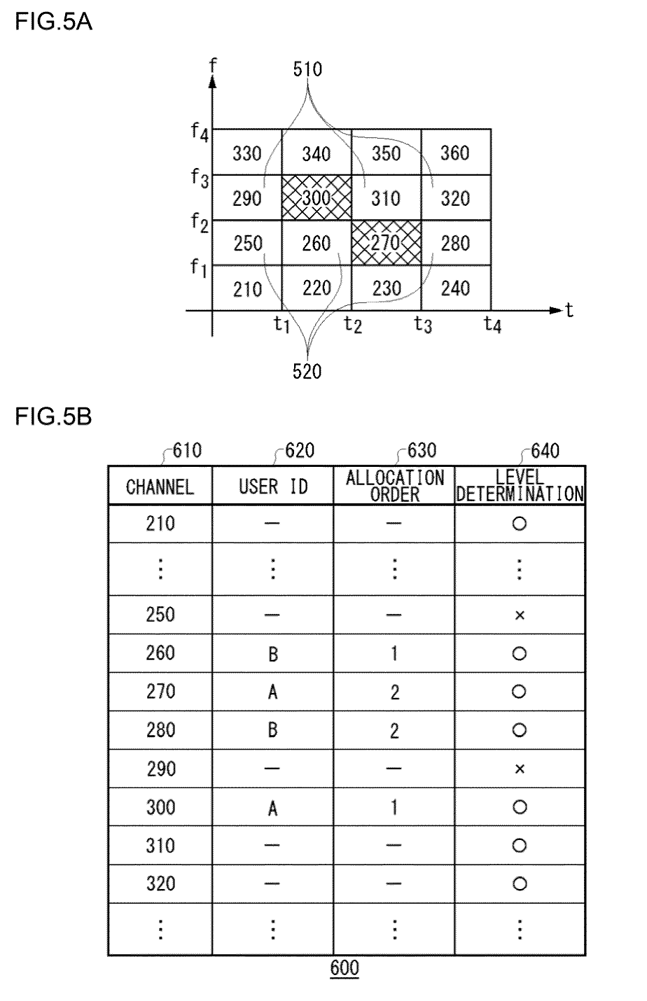

Another example will be shown here. FIG. 5A shows a second exemplary assignment in the channel allocation unit 50 of FIG. 1. FIG. 5B shows an example of the allocation management table 600 in the exemplary assignment of FIG. 5A. In this example, it is assumed that the channel assignment request is further made by the terminal apparatus A to which two channels 200, namely the tenth channel 300 and the seventh channel 270, have already been assigned.

In this case, the tenth channel 300 is first assigned and then the seventh channel 270 is assigned. In such a case as this where the third channel and its subsequent channels are to be further assigned to the same terminal apparatus, a channel assigned more recently is preferentially taken into consideration. This is because the channel assigned more recently is used not long ago and therefore the reliability thereof is considered to be high.

More specifically, the channel allocation unit 50 searches and retrieves channels 200 having the same frequency as that of the seventh channel 270 assigned more recently, and selects the fifth channel 250, the sixth channel 260 and the seventh channel 270 as second assignment candidate channels 520.

The allocation management table 600 of FIG. 5B shows that any of the second assignment candidate channels 520 are not assignable. In such a case, the channel allocation unit 50 determines if a channel, namely the tenth channel 300, assigned immediately before that assigned most recently is assignable or not. First assignment candidate channels 510 having the same frequency as that of the tenth channel 300 are the ninth channel 290, the eleventh channel 310 and the twelfth channel 320. Of those channels, the assignable ones are the eleventh channel 310 and the twelfth channel 320. The channel allocation unit 50 selects a channel 200 to be assigned to the terminal A through the above-described allocation selection processing.

If there isn't any assignable channel having the same frequency in the channels 200 assigned in the past, the channel allocation unit 50 may select an assignable channel from among the first channel 210 to the sixteenth channel 360 without taking consideration of the assignments made in the past.

These above-described structural components may be implemented hardwarewise by a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

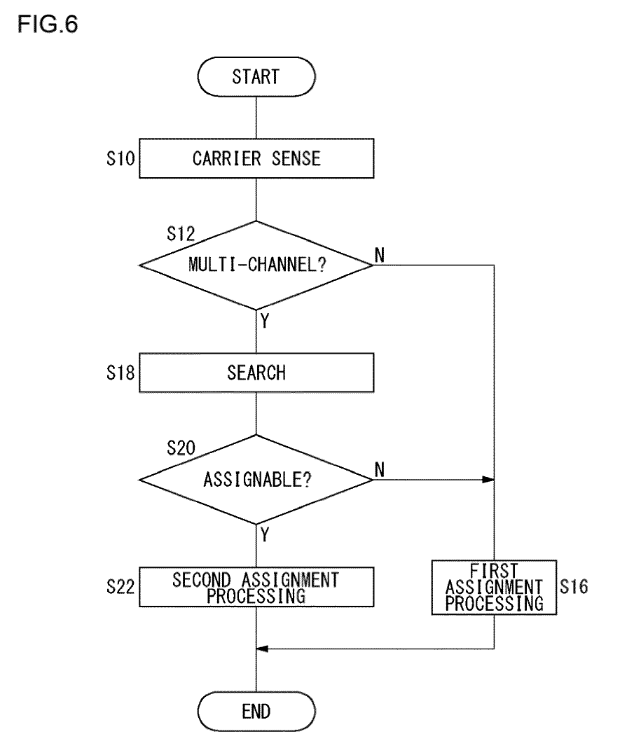

FIG. 6 shows an exemplary operation of the base station apparatus 100 of FIG. 1. The channel measurement unit 20 first performs carrier sense of signals arrived from other stations and then measures the interference wave levels of the respective channels 200 to be assigned (S10). When a request for channel assignment is received by the receiver 10 from a terminal apparatus, the channel allocation unit 50 accesses the memory 40 and verifies whether any channel has already been assigned to this terminal apparatus or not (S12).

If no channel has been assigned thereto (N of S12), the channel allocation unit 50 will assign a channel which is not currently used for other terminal apparatuses and which has the minimum interference level (S16). If, on the other hand, any channel has been assigned thereto (Y of S12), the channel allocation unit 50 will assign an assignable channel 200 out of the channels assigned in the past, namely the channels having the same frequency as that of the channel used more recently (S18).

If an assignable channel is selected (Y of S20), the channel allocation unit 50 will assign the selected channel to the terminal apparatus (S22). If there is no assignable channel in consideration of any channels assigned in the past (N of S20), the channel allocation unit 50 will perform the assignment processing of S16 regardless of whether the assignment is made in the past or not.

As described above, if a second channel and channels subsequent thereto are to be further assigned, the assignment processing is performed in consideration of the already assigned channel(s) and therefore a channel with improved quality can be assigned. Also, a channel having the same frequency as that assigned in the past is assigned, so that the channel in which the delayed waves are less likely to occur can be assigned.

Also, if the third channel and its subsequent channels are to be further assigned to the same terminal apparatus, a channel having the same frequency as that assigned more recently is assigned. Hence, the channel with satisfactory quality can be assigned more assuredly. Also, if the third channel and its subsequent channels are to be further assigned to the same terminal apparatus, a channel having the same frequency as that assigned for the first time is assigned. Hence, the channel with satisfactory quality can be selected stably.

The present invention has been described based on the embodiment. This embodiment is intended to be illustrative only, and it is understood by those skilled in the art that various modifications to constituting elements and processes could be developed and that such modifications are also within the scope of the present invention.

In the above embodiment of the present invention, a description has been given of a case where all of the channels 200 are subjected to carrier sense. However, this should not be considered as limiting and, for example, only the channels 200 having the same frequency as that of the channels assigned in the past may be subjected to carrier sense, instead. In such an embodiment as this, the processing load can be reduced.

Also, in the above embodiment of the present invention, a description has been given of an example using the multicarrier TDMA scheme where a channel is defined by a combination of the frequency resource and the temporal resource. However, the embodiment is not limited thereto and a scheme where a channel is defined by a combination of the frequency resource and a resource other than the frequency resource may be used. For example, the embodiment is also applicable to a scheme where a channel is defined by a combination of the frequency resource and the spatial resource or a scheme where a channel is defined by a combination of the frequency resource and a code resource.

### INDUSTRIAL APPLICABILITY

The present invention allocates channels to terminal apparatuses efficiently.

What is claimed is:

1. A base station apparatus, comprising:
a receiver configured to receive a request for channel assignment from a terminal apparatus;
a measurement unit configured to perform carrier sense of channels defined by a combination of a frequency resource and a resource other than the frequency resource, upon receipt of the request by said receiver; and
a channel allocation unit configured to assign any of the channels, on which the carrier sense has been performed by said measurement unit, to the terminal,
wherein when a second channel and channels subsequent thereto are further assigned to the same terminal apparatus, said channel allocation unit assigns a channel having the same frequency as that of a frequency resource in such a manner that the frequency resource of the already assigned channel is prioritized over the other resources.

2. A base station apparatus according to claim 1, wherein when a third channel and channels subsequent thereto are further assigned to the same terminal apparatus, said channel allocation unit assigns a channel having the same frequency as that assigned more recently, to the same terminal apparatus.

3. A base station apparatus according to claim 1, wherein when a third channel and channels subsequent thereto are further assigned to the same terminal apparatus, said channel allocation unit assigns a channel having the same frequency as that assigned for the first time, to the same terminal apparatus.
